(19) United States
(12) Patent Application Publication
(10) Pub. No.: US 2026/0064850 A1
(43) Pub. Date: Mar. 5, 2026

(54) VERIFIER DEVICE, VERIFICATION METHOD, STORAGE MEDIUM STORING VERIFICATION PROGRAM, AND REMOTE ATTESTATION SYSTEM

(71) Applicant: DENSO CORPORATION, Kariya-city (JP)

(72) Inventors: Madoka ASAI, Kariya-city (JP); Tomonori IKUSE, Kariya-city (JP); Yasuharu SUGANO, Kariya-city (JP); Takeshi NAKAMURA, Kariya-city (JP); Carlos MORA-GOLDING, Southfield, MI (US); Ameer KASHANI, Southfield, MI (US)

(21) Appl. No.: 18/825,094

(22) Filed: Sep. 5, 2024

(51) Int. Cl. G06F 21/57

(52) U.S. Cl. CPC G06F 21/577; G06F 2221/033; G06F 2221/034

(57) ABSTRACT

The verifier device is configured to receive dynamic data or a measurement value calculated using the dynamic data from the prover device that places and executes a software in a memory, the software including the dynamic data whose content changes, receive basic data from the prover device, the basic data being capable of estimating the dynamic data that should originally be placed in the memory, store master dynamic data, whose data content changes, and which is included in master software that is a copy of the software, and master basic data, which is capable of estimating the master dynamic data, in association with each other, and verify the dynamic data or the measurement value using the master dynamic data associated with the master basic data corresponding to the basic data to output a verification result.

### TECHNICAL FIELD

The present disclosure relates to a verifier device that verifies the integrity of software, including dynamic data that changes in content, in a remote attestation system in which the integrity of software executed by a prover device is verified by the verifier device. As an example, the present disclosure relates to a remote attestation system in which all or some of devices constituting the system are mounted in a vehicle.

### BACKGROUND

A related art discloses a remote attestation scheme that verifies the integrity of processes and systems in execution. In the related art, a prover obtains a start address and size, and measurement result of a process or system memory region and transmits these to a verifier. The verifier verifies the integrity of the prover by comparing a correct value prepared in advance, or a correct value calculated based on the received information, with the received measurement result.

### SUMMARY

The verifier device is configured to receive dynamic data or a measurement value calculated using the dynamic data from the prover device that places and executes a software in a memory, the software including the dynamic data whose content changes, receive basic data from the prover device, the basic data being capable of estimating the dynamic data that should originally be placed in the memory, store master dynamic data, whose data content changes, and which is included in master software that is a copy of the software, and master basic data, which is capable of estimating the master dynamic data, in association with each other, and verify the dynamic data or the measurement value using the master dynamic data associated with the master basic data corresponding to the basic data to output a verification result.

### BRIEF DESCRIPTION OF THE DRAWINGS

The objects, features, and advantages of the present disclosure will become more apparent from the following detailed description made with reference to the accompanying drawings. In the drawings:

FIGS. 1A to 1C are explanatory diagrams illustrating the arrangement of a prover device, a verifier device, and a remote attestation system;

FIG. 2 is an explanatory diagram illustrating the arrangement of the prover device and the verifier device in a vehicle;

FIG. 3 is an explanatory diagram illustrating software including dynamic data;

FIGS. 4A and 4B are explanatory diagrams illustrating software executed by a prover device according to a first embodiment;

FIG. 5 is a flowchart illustrating software creation processing executed by the prover device according to the first embodiment;

FIG. 6 is a block diagram illustrating a configuration example of the prover device according to the first embodiment;

FIGS. 7A and 7B are explanatory diagrams illustrating a measurement instruction received by a measurement instruction reception unit and processing contents of a measurement unit;

FIG. 8 is a block diagram illustrating a configuration example of a verifier device according to the first embodiment;

FIGS. 9A and 9B are explanatory diagrams illustrating information stored in advance in the storage unit of the verifier device;

FIG. 10 is an explanatory diagram illustrating a measurement instruction transmitted from the verifier device to the prover device;

FIG. 11 is an explanatory diagram illustrating a measurement result transmitted from the verifier device to the prover device;

FIG. 12 is an explanatory diagram illustrating an evidence request instruction transmitted from the verifier device to the prover device;

FIG. 13 is an explanatory diagram illustrating evidence data transmitted from the prover device to the verifier device;

FIG. 14 is an explanatory diagram illustrating a modified example of the information stored in advance in the storage unit of the verifier device;

FIG. 15 is a flowchart illustrating the operations of the prover device and the verifier device according to the first embodiment;

FIG. 16 is a flowchart illustrating the operations of the prover device and the verifier device according to the first embodiment;

FIG. 17 is a block diagram illustrating a configuration example of a prover device according to a second embodiment;

FIG. 18 is a block diagram illustrating a configuration example of a verifier device of the second embodiment; and

FIG. 19 is a flowchart illustrating the operations of the prover device and the verifier device according to the second embodiment.

### DETAILED DESCRIPTION

In recent years, various electronic control devices connected through in-vehicle networks are mounted in automobiles, and software is executed in each electronic control device. However, there is a possibility that such software may be tampered with by a cyberattack or the like due to being compromised, causing the software to operate differently from the original plan. To address these issues, the use of remote attestation is being considered. Remote attestation is a mechanism that can confirm the integrity of a device or software on the device during remote operation or the like for the purpose of device management and operation.

As a result of detailed studies, the present inventor has found the following difficulties.

As disclosed in the related art, the remote attestation scheme is a scheme to verify the integrity of a device or software on the device by comparing a correct value with a measurement result. However, when verification target software includes data that changes in content, the measurement result of the software changes depending on the value of the data, making it impossible to prepare a correct value in advance. For this reason, it is difficult to verify the integrity of software using the conventional remote attestation scheme.

Therefore, an object of the present disclosure is to implement a verifier device and the like capable of verifying the integrity of software, including dynamic data that changes in content, in a remote attestation system.

According to one aspect of the present disclosure, a verifier device constituting a remote attestation system together with a prover device is provided. The verifier device includes: a dynamic data reception unit configured to receive dynamic data or a measurement value calculated using the dynamic data from the prover device that places and executes a software in a memory, the software including the dynamic data whose content changes; a basic data reception unit configured to receive basic data from the prover device, the basic data being capable of estimating the dynamic data that should originally be placed in the memory; a master storage unit configured to store master dynamic data, whose data content changes, and which is included in master software that is a copy of the software, and master basic data, which is capable of estimating the master dynamic data, in association with each other; a verification unit configured to verify the dynamic data or the measurement value received by the dynamic data reception unit using the master dynamic data associated with the master basic data corresponding to the basic data, and outputs a verification result.

With the above configuration, the verifier device and the like according to the present disclosure can verify the measurement result received from the prover device using basic data that enables a correct value of dynamic data to be estimated, thereby verifying the integrity of the dynamic data, and ultimately the integrity of the software that includes the dynamic data.

Hereinafter, embodiments of the present disclosure will be described with reference to the drawings.

When there are a plurality of embodiments (including modified examples, as the same applies hereinafter in this section), the configuration disclosed in each embodiment is not limited to that embodiment alone, but can be combined across embodiments. For example, the configuration disclosed in one embodiment may be combined with another embodiment. The configurations disclosed respectively in a plurality of embodiments may be collected and combined.

### 1. Premise of Each Embodiment

### (1) Arrangement of Prover Device, Verifier Device, and Remote Attestation System

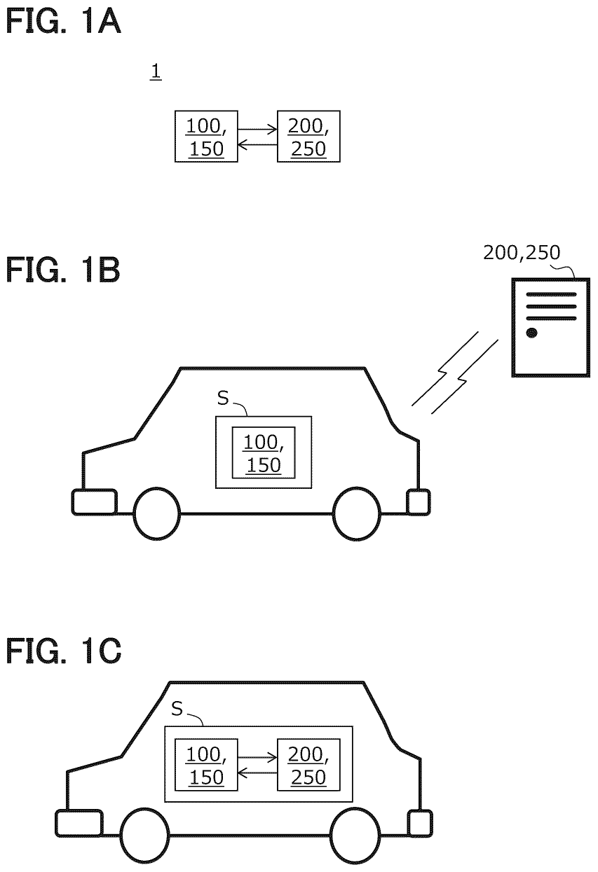

FIGS. 1A to 1C are diagrams illustrating the arrangement of the prover devices 100, 150, the verifier devices 200, 250, and the remote attestation system 1. First, an outline of each device and its connection method will be described with reference to FIG. 1A.

Each of the prover devices 100, 150 is a device that places “software” in a “memory” and executes the software. This device is a device that is a target for proving the integrity of the software executed, that is, a device that provides evidence information for proving its own integrity. Therefore, the device is referred to as a prover device. The prover devices 100, 150 will hereinafter be collectively referred to as a prover device 100 or similar.

Each of the verifier devices 200, 250 is a device that verifies the integrity of software executed by the prover device 100, that is, a device that verifies the integrity of the prover device based on the evidence information received from the prover device. Therefore, the device is referred to as a verifier device. The verifier devices 200 and 250 will hereinafter be collectively referred to as the verifier device 200 or similar.

The prover device 100 or similar and the verifier device 200 or similar are collectively referred to as the remote attestation system 1.

For the “memory”, a position-identifiable readable/writable recording medium is sufficient, which may include nonvolatile memory such as flash memory or a hard disk, in addition to volatile memory such as random-access memory.

The prover device 100 or similar and the verifier device 200 or similar are connected using a wired communication method or a wireless communication method to transmit and receive a measurement instruction, a measurement result, an evidence collection instruction, evidence data, and the like, which will be described later.

Examples of the wired communication method include the Internet, a fixed telephone line, and Ethernet (registered trademark). When an in-vehicle network is used, a controller area network (CAN) or a local interconnect network (LIN) can be used.

Examples of the wireless communication method include IEEE802.11 (Wi-Fi (registered trademark)), IEEE802.16 (WiMAX (registered trademark)), wideband code division multiple access (W-CDMA), high-speed packet access (HSPA), long-term evolution (LTE), long-term evolution advanced (LTE-A), fourth generation (4G), fifth generation (5G), and the like. In addition, dedicated short-range communication (DSRC), Bluetooth low energy (BLE), or Bluetooth (registered trademark) may be used.

As to which communication method to use, it is sufficient to adopt an optimal communication method according to the positions at which the prover device 100 or similar and the verifier device 200 or similar are installed, the distance therebetween, and other factors.

The communication between the prover device 100 or similar and the verifier device 200 or similar is desirably protected by a secure communication protocol such as mTLS.

The positions where the prover device 100 or similar and the verifier device 200 or similar are disposed are arbitrary. That is, the positions of the prover device 100 or similar and the verifier device 200 or similar and the distance between the prover device 100 or similar and the verifier device 200 or similar are arbitrary.

For example, as illustrated in FIG. 1B, the prover device 100 or similar may be mounted in a vehicle, and the verifier device 200 or similar may be provided outside the vehicle. For example, the prover device 100 or similar may be an “electronic control device” (electric control unit, ECU) “mounted” in a vehicle that is a “moving object”, and the verifier device 200 or similar may be a server device installed outside the vehicle that is the “moving object”. That is, the prover device 100 or similar is located inside an electronic control system S, and the verifier device 200 or similar is located outside the electronic control system S. The electronic control device is a device constituting the electronic control system of the vehicle. In this case, the prover device 100 or similar and the verifier device 200 or similar are connected by, for example, Wi-Fi or 5G.

Alternatively, as illustrated in FIG. 1C, both the prover device 100 or similar and the verifier device 200 or similar may be mounted in the vehicle. For example, the prover device 100 or similar may be an “electronic control device” “mounted” in the vehicle that is the “moving object”, and the verifier device 200 or similar may be another “electronic control device” “mounted” in the vehicle that is the “moving object”. That is, both the prover device 100 or similar and the verifier device 200 or similar are located inside the electronic control system S. In this case, the prover device 100 or similar and the verifier device 200 or similar are connected by Ethernet or CAN.

In addition, both the prover device 100 or similar and the verifier device 200 or similar may be provided outside the vehicle, regardless of which vehicle.

The “moving object” refers to a movable object, and a moving speed is arbitrary. Naturally, a case where the moving object is stopped is also included. Examples thereof include, but are not limited to, an automobile, a motorcycle, a bicycle, a pedestrian, a ship, an aircraft, and an object mounted therein.

The term “mounted” includes not only a case where the device is directly fixed to the moving object but also a case where the device is not fixed to the moving object but moves together with the moving object. Examples thereof include a case where a person on the moving object carries the device and a case where the device is mounted in a load placed on the moving object.

The “electronic control device” may be a virtualized electronic control device implemented using virtualization technology, in addition to a physically independent electronic control device.

In each embodiment to be described later, a description will be given on the premise of the arrangement of FIG. 1B.

### (2) Arrangement of Prover Device 100 or Similar and Verifier Device 200 or Similar in Vehicle

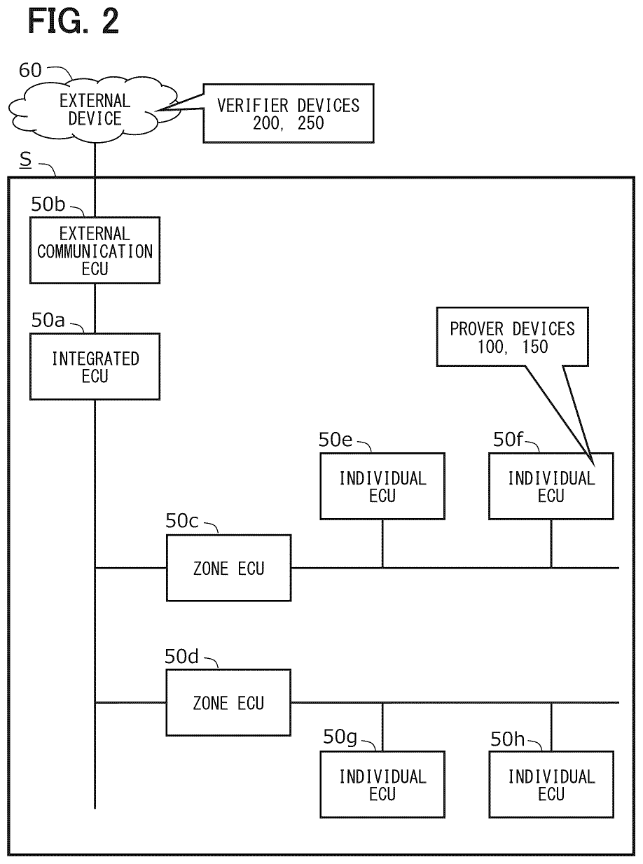

FIG. 2 is a diagram illustrating the electronic control system S mounted in the vehicle and an example of the arrangement of the prover device 100 or similar and the verifier device 200 or similar in the electronic control system S.

The electronic control system S includes a plurality of ECUs 50 and an in-vehicle network that connects these ECUs. FIG. 2 illustrates eight ECUs (ECU 50a to ECU 50h), but naturally, the electronic control system S includes any number of ECUs. In the following description, ECU 50 or each ECU 50 is used to collectively describe one or more electronic control devices as a whole, and ECU 50a, ECU 50b, ECU 50c, . . . are used to identify and describe individual electronic control devices.

In the case of FIG. 2, the ECUs 50 are connected via an in-vehicle communication network such as a controller area network (CAN) or a local interconnect network (LIN). Alternatively, the connection may be made using any wired or wireless communication method, such as Ethernet (registered trademark). Wi-Fi (registered trademark), or Bluetooth (registered trademark).

The connection refers to a state where data can be exchanged and includes not only a case where different pieces of hardware are connected via a wired or wireless communication network, but also a case where virtual ECUs (also referred to as virtual machines) implemented on the same hardware are connected to each other virtually.

The electronic control system S illustrated in FIG. 2 includes an integrated ECU 50a, an external communication ECU 50b, zone ECUs (50c, 50d), and individual ECUs (50e to 50h).

The integrated ECU 50a is an ECU equipped with a function to control the entire electronic control system S and a gateway function to mediate communication between the ECUs 50. The integrated ECU 50a may also be referred to as a gateway ECU (G-ECU) or a mobility computer (MC). The integrated ECU 50a may be a relay device or a gateway device.

The external communication ECU 50b is an ECU including a communication unit that communicates with an external device 60 provided outside the vehicle. The communication method used by the external communication ECU 50b is the wireless communication method or the wired communication method described in FIGS. 1A to 1C.

To implement a plurality of communication methods, a plurality of external communication ECUs 50b may be provided. Instead of providing the external communication ECU 50b, the integrated ECU 50a may include the function of the external communication ECU 50b.

The zones ECU (50c, 50d) are ECUs equipped with gateway functions appropriately disposed according to the arrangement places and functions of the individual ECUs (50e to 50h). For example, the zone ECU 50c is an ECU with a gateway function that mediates communication between the individual ECU 50e and the individual ECU 50f arranged in the front of the vehicle and another ECU 50. The zone ECU 50d is an ECU with a gateway function that mediates communication between the individual ECU 50g and the individual ECU 50h arranged in the rear of the vehicle and another ECU 50.

The individual ECUs (50e to 50h) can be configured by ECUs with any function. Examples thereof include: a drive system electronic control device that controls the engine, steering wheel, brake, and the like; a vehicle body system electronic control device that controls the meter, power window, and the like; an information system electronic control device such as a navigation device; and a safety control system electronic control device that performs control to prevent collision with obstacles or pedestrians. The ECUs 50 may not be arranged in parallel, and may be classified into a master and a slave.

Each ECU 50 stores software corresponding to its function and reads the software into memory for execution as necessary. Accordingly, each ECU 50 can be the prover device 100 or similar.

In FIG. 2, a case where the individual ECU 50f is the prover device 100 or similar will be described as an example.

When the verifier device 200 or similar is provided outside the vehicle as illustrated in FIG. 1B, the external device 60 of FIG. 2 is the verifier device 200 or similar. When the verifier device 200 or similar is mounted in the vehicle as illustrated in FIG. 1C, for example, the integrated ECU 50a can be set as the verifier device 200 or similar.

### 2. First Embodiment

In a first embodiment, the remote attestation system 1 when dynamic data included in software is data that changes in content according to an execution state of a program will be described.

### (1) Preparation of Software and Dynamic Data Management Table

The creation of software executed by the prover device 100 will be described as a premise of the remote attestation system 1 of the present embodiment. The software executed by the prover device 100 of the present embodiment includes dynamic data that changes in content according to the execution state of the program.

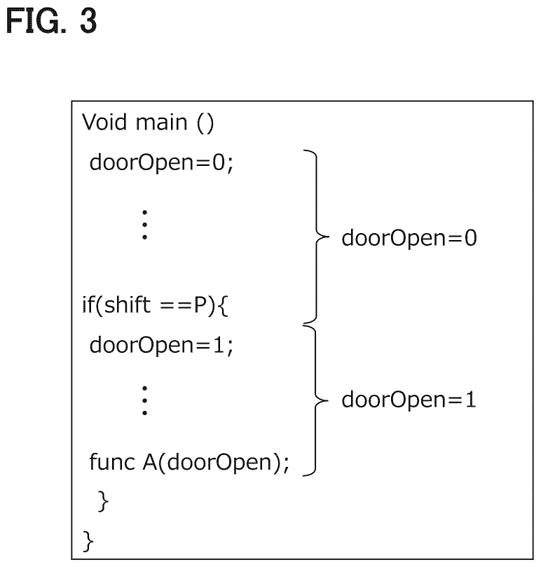

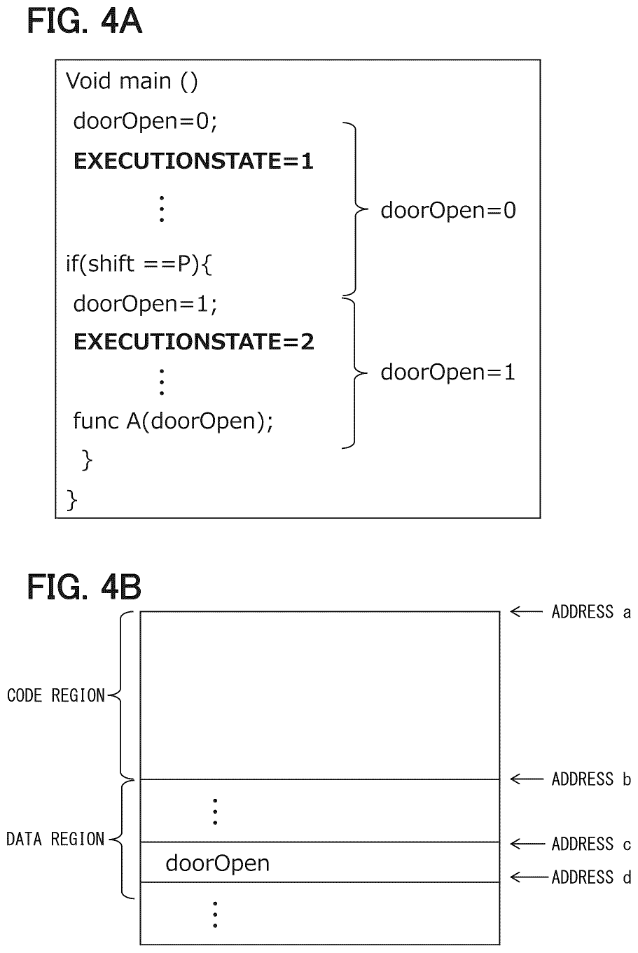

A specific example of the software including dynamic data that changes in content according to the execution state of the program will be described with reference to FIGS. 3, 4A, and 4B. FIG. 3 illustrates a program for controlling the door lock of the vehicle. According to the program of FIG. 3, first, an initial value [0] is set to a variable doorOpen (doorOpen=0). When the shift lever is in the P state (Shift==P), [1] is set to the variable doorOpen (doorOpen=1). When the argument of the function A (func A) is [1], the door is unlocked. According to the software illustrated in FIG. 3, the variable doorOpen changes to a value of either [0] or [1] depending on the execution state of the program.

Next, software including a program generated from the program described in FIG. 3 and executed by the prover device 100 will be described with reference to FIGS. 4A and 4B. FIG. 4A illustrates a program obtained by inserting program code (EXECUTIONSTATE=1, EXECUTIONSTATE=2) (corresponding to “second program code”) into the program illustrated in FIG. 3. The inserted program code is program code for setting the value of the flag EXECUTIONSTATE, and is inserted immediately after program code (corresponding to “first program code”) for setting the value of the dynamic data (doorOpen). FIG. 4B illustrates a state where software including the program illustrated in FIG. 4A is placed in the memory. Program code as illustrated in FIG. 3 is placed in a region from address a to address b, and data is placed in a region after address b. In a region from address c to address d, the value of the variable doorOpen, which is dynamic data that changes in content according to the execution state of the program, is placed.

According to FIG. 4A, the program code (EXECUTIONSTATE=1) is executed immediately after the program code (doorOpen=0) is executed. Thus, [1] is set to the flag EXECUTIONSTATE as soon as the value of [0] is set to the variable doorOpen. Similarly, the program code (EXECUTIONSTATE=2) is executed immediately after the program code (doorOpen=1) is executed. Thus, [2] is set to the flag EXECUTIONSTATE as soon as the value of the variable doorOpen [1] is set. That is, when the flag EXECUTIONSTATE is [1], the variable doorOpen that should be originally placed in the memory can be estimated to be [0]. In addition, when the flag EXECUTIONSTATE is [2], the variable doorOpen that should be originally placed in the memory can be estimated to be [1]. If the value set to the variable doorOpen is [1] even though the flag EXECUTIONSTATE is [1], it can be seen that the value of the variable doorOpen has been tampered with. As described above, the flag EXECUTIONSTATE illustrated in FIG. 4A is a flag enabling the identification of the variable doorOpen that should be originally placed in the memory. As described later, the flag EXECUTIONSTATE is data serving as a basis for estimating the dynamic data and is thus referred to as basic data.

Although not illustrated in FIG. 4B, the value set to the flag EXECUTIONSTATE may be placed after the dynamic data (doorOpen) in the software in the memory (e.g., the region from address c to address d). However, since the flag EXECUTIONSTATE is the basic data for estimating dynamic data, it is desirable that the flag is not tampered with by an attacker or the like. Therefore, the value set to the flag EXECUTIONSTATE is desirably protected by security technologies such as a trusted execution environment (TEE) or stored in highly secure memory.

It is sufficient that the program code for setting the value of the flag that enables the dynamic data to be estimated is inserted into the software, and the program code for setting the value of the flag does not necessarily have to be inserted immediately after the program code for setting the value of the dynamic data. However, when the program code for setting the value of the flag is not inserted immediately before or immediately after the program code for setting the value of the dynamic data, a time lag may occur between when the value of the dynamic data is set and when the flag is set to a value that enables the dynamic data to be estimated. For example, when there are three program codes between the program code for setting the value of the dynamic data and the program code for setting the value of the flag, a value that enables the dynamic data to be estimated is not set to the flag during the execution of the other three program codes. Therefore, the program code for setting the value of the flag is desirably inserted immediately before or immediately after the program code for setting the value of the dynamic data.

As illustrated in FIG. 4B, the software is placed and executed in the memory 102 of the prover device 100. Moreover, master software, which is a “copy” of the software illustrated in FIG. 4B, is also stored in the master storage unit 201 of the verifier device 200. The master storage unit 201 of the verifier device 200 further stores a dynamic data management table that associates the master dynamic data included in the master software, that is, the variable doorOpen ([0] or [1]), with the flag enabling the identification of the master dynamic data, that is, the flag EXECUTIONSTATE ([1] or [2]).

The “copy” of the software refers to the same content as the software, and it does not matter whether the software is copied from the original. For example, the software may have been produced as an original, or the “copy” itself may be an original.

In the dynamic data management table of the present embodiment, one piece of dynamic data, that is, the variable doorOpen, is associated with one piece of basic data, that is, the flag EXECUTIONSTATE. However, a plurality of pieces of dynamic data may be associated with one piece of basic data.

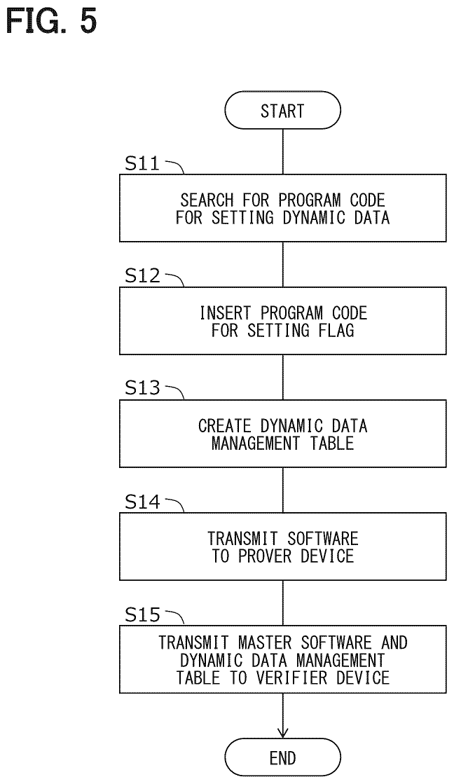

A series of preprocessing executed before remote attestation in the present embodiment will be described with reference to FIG. 5.

First, software is analyzed to search for program code (e.g., doorOpen=0, doorOpen=1) for setting dynamic data that is included in the software and changes in content according to the execution state of the program (S11).

Immediately after the program code searched for in S11, program code (e.g., EXECUTIONSTATE=1, EXECUTIONSTATE=2) is inserted to set a flag enabling the identification of the dynamic data that should be originally placed in the memory (S12).

A dynamic data management table is created in which master dynamic data included in master software, which is a copy of the software, is associated with a flag enabling the master dynamic data to be identified (S13).

The software with the program code inserted is transmitted to the prover device 100 (S14).

The master software and the dynamic data management table are transmitted to the verifier device 200 (S15).

In FIG. 5, the pre-processing when software is created by a device other than the prover device 100 and the verifier device 200 has been described as an example. However, the creation of software as illustrated in FIGS. 4A and 4B may be executed by the prover device 100 or the verifier device 200. Further, the verifier device 200 that has received the master software may create the dynamic data management table from the master software.

### (2) Configuration of Prover Device 100

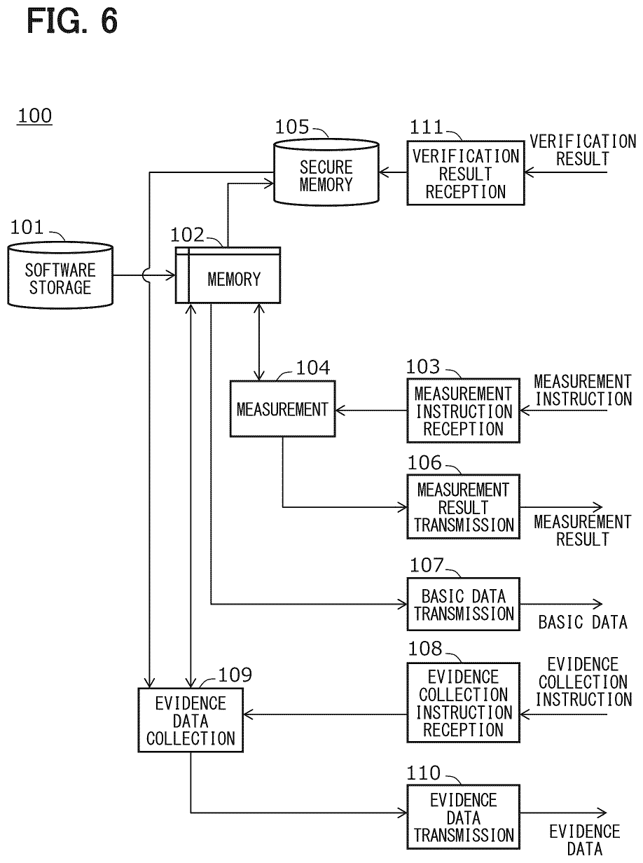

A configuration example of the prover device 100 according to the present embodiment will be described with reference to FIG. 6. The prover device 100 includes a software storage unit 101, memory 102, a measurement instruction reception unit 103, a measurement unit 104, a secure memory 105, a measurement result transmission unit 106, a basic data transmission unit 107, an evidence collection instruction reception unit 108, an evidence data collection unit 109, an evidence data transmission unit 110, and a verification result reception unit 111.

The prover device 100 can include a general-purpose central processing unit (CPU), volatile memory such as random-access memory (RAM), nonvolatile memory such as read-only memory (ROM), flash memory, or a hard disk, various interfaces, and internal bus that connects these components. By executing software on these pieces of hardware, it is possible to perform the functions of the functional blocks illustrated in FIG. 6. The same applies to the verifier device 200 to be described later.

The prover device 100 reads the software stored in the software storage unit 101 into the memory 102 to place the software in the memory and execute the software. The placement position of the software in the memory may be either the same at all times or different at each reading. When the position is different for each reading, it is desirable to share the placement position with the verifier device 200. When the memory 102 is a random-access memory (RAM), the placement position can be indicated by, for example, a start address indicating the leading position of the software and the size of the software. The size of the software may be omitted when the size of the software is known in the verifier device 200. Alternatively, the placement position is a start address indicating the leading position and an end address indicating the trailing position. In the present embodiment, the software stored in the software storage unit 101 is software into which program code for setting a flag is inserted as illustrated in FIGS. 4A and 4B.

The measurement instruction reception unit 103 receives a measurement instruction generated by the verifier device 200 from the verifier device 200. In the present embodiment, the measurement instruction includes measurement region information indicating a region to be measured in the software. The measurement region information only needs to be information that can specify all or a part of the software in the memory, and examples thereof include an address and a size.

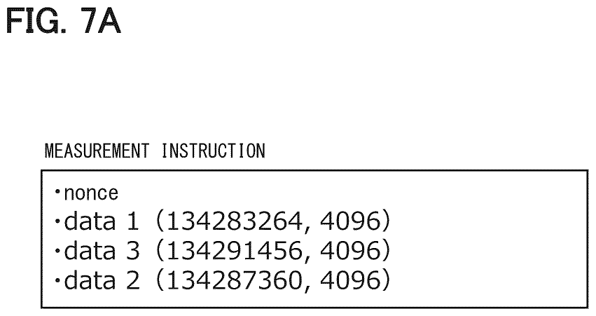

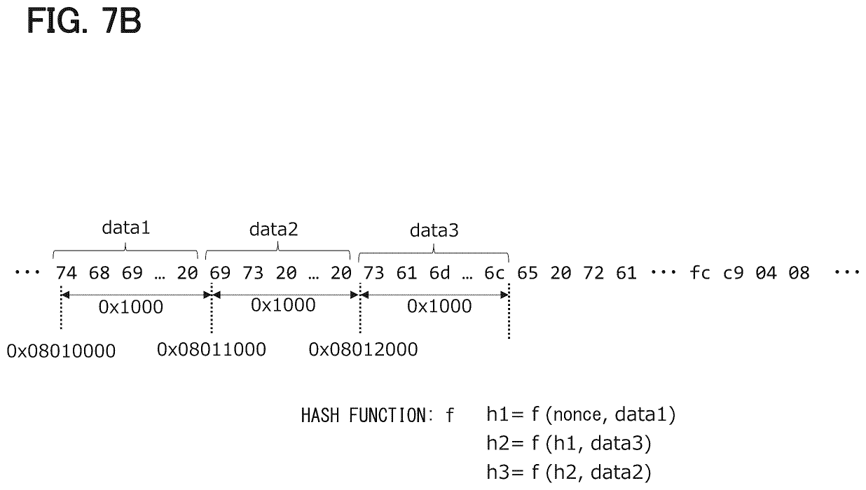

A specific example of the measurement instruction received by the measurement instruction reception unit 103 will be described with reference to FIGS. 7A and 7B. In the case of FIG. 7A, the received measurement instruction includes three regions as measurement region information in addition to a nonce. The first region is indicated by data1, with a start address of 134283264 (decimal notation), and a size of 4096 bytes. The second region is indicated by data3, with a start address of 134291456 (decimal notation), and a size of 4096 bytes. A third region is indicated by data2, with a start address of 134287360 (decimal notation), and a size of 4096 bytes.

This measurement instruction also includes an instruction to execute measurement in the order of data1, data3, and data2. That is, the order of data1, data3, and data2 corresponds to the measurement order information.

The nonce is, for example, a random number generated by the verifier device 200, but may also be any numerical value with low predictability, even if not completely random.

Based on the measurement instruction received by the measurement instruction reception unit 103, the measurement unit 104 reads software placed in the memory 102 and calculates a measurement value. In the present embodiment, a “hash value” is calculated as the “measurement value” by using at least dynamic data from the software placed in the memory 102.

The “hash value” is an output value itself calculated by a function that calculates a unique value for an input value, or a value obtained by performing processing such as encryption on the output value, and an algorithm used for the function is arbitrary. For example, the “hash values” include not only a value calculated by a one-way hash function such as SHA512 but also a value calculated by a cipher-based MAC (CMAC), a value calculated by a hash-based MAC (HMAC), and a signature.

The “measurement value” calculated using dynamic data may be any value calculated using dynamic data, and may be a value calculated using both dynamic data and other data.

In FIG. 7B, data1 of the software placed in the memory 102 has a start address of 0x08010000 (hexadecimal notation) and a size of 0x1000 (hexadecimal notation), data3 has a start address of 0x08012000 (hexadecimal notation) and a size of 0x1000 (hexadecimal notation), and data2 has a start address of 0x08011000 (hexadecimal notation) and a size of 0x1000 (hexadecimal notation). Therefore, based on the respective arguments, the measurement unit 104 reads the corresponding ranges of the software and calculates the respective hash values as follows:

$$h 1 = f ( nonce , data 1 )$$

$$h 2 = f ( h 1 , data 3 )$$

$$h 3 = f ( h 2 , data 2 )$$

(where f is a hash function).

For example, when data1 is the region from address a to address b illustrated in FIG. 4B, data3 is the region from address c to address d, and data2 is the region from address b to address c, the measurement unit 104 calculates the respective hash values h1, h2, h3 for the three regions of the software illustrated in FIG. 4B.

In FIGS. 7A and 7B, the hash value is calculated for each of the three regions of the software illustrated in FIG. 4B. However, when the measurement instruction designates only some of the regions as the measurement target, the hash value of only the designated region is calculated. For example, when the measurement instruction designates only data3 as the measurement region, the measurement unit 104 reads only the region from address c to address d illustrated in FIG. 4B, that is, dynamic data, and calculates the measurement value using the dynamic data. When a plurality of pieces of dynamic data are placed in the region from address c to address d, the measurement unit 104 calculates the hash value using the plurality of pieces of dynamic data.

When the measurement instruction designates a region including only program code (doorOpen=0, doorOpen=1) for setting dynamic data and program code (EXECUTIONSTATE=1, EXECUTIONSTATE=2) for setting a flag in addition to the region from address c to address d, for example, the measurement unit 104 reads the dynamic data, the program code for setting the dynamic data, and the program code for setting the flag out of the software placed in the memory 102 and calculates the measurement value.

The start address may be included as the argument of the hash function.

In FIGS. 7A and 7B, the hash value is calculated by dividing the measurement region into three regions based on the measurement region information and the measurement order information included in the measurement instruction. However, if the measurement instruction does not include an instruction to divide the region, the hash value may be calculated using the nonce and the raw data of the software in the memory 102.

The secure memory 105 is memory that stores dynamic data used by the measurement unit 104 to calculate a hash value. The secure memory 105 is a secure memory that is highly secure and is unlikely that stored information is tampered with by a cyberattack or the like. The dynamic data stored in the secure memory 105 is discarded from the secure memory 105 when the verification result reception unit 111 receives a verification result from the verifier device 200 indicating that the integrity of the software has been confirmed.

In addition to the dynamic data, the secure memory 105 may store software used by the measurement unit 104 to calculate a measurement value or a value of basic data when the measurement value is calculated using the dynamic data.

The measurement result transmission unit 106 transmits the hash value calculated and obtained by the measurement unit 104 to the verifier device 200 as a measurement result. In the case of FIGS. 7A and 7B, the measurement result transmission unit 106 transmits the hash values h1, h2, h3.

In addition to the hash value, a time when the hash value was obtained and error information indicating the address and size of the region to be measured for which measurement has failed may also be transmitted.

The basic data transmission unit 107 transmits, to the verifier device 200, the value of the basic data set when the measurement unit 104 calculates the measurement value using the dynamic data. In the case of the software in FIGS. 4A and 4B, the basic data transmission unit 107 transmits the value of the flag EXECUTIONSTATE as the basic data. When the measurement value is calculated using a plurality of pieces of dynamic data, the basic data transmission unit 107 transmits basic data that enables each of the plurality of pieces of dynamic data to be estimated.

In the present embodiment, the measurement result transmission unit 106 transmits the measurement result and the basic data transmission unit 107 transmits the basic data. However, the measurement result and the basic data may be transmitted together to the verifier device 200.

Based on the measurement result transmitted from the measurement result transmission unit 106, the evidence collection instruction reception unit 108 receives the evidence collection instruction generated by the verifier device 200. For example, when the verifier device 200 detects tampering of software being executed in the memory 102 of the prover device 100, the verifier device 200 generates and transmits, to the prover device 100, an evidence collection instruction for requesting transmission of the software being executed as evidence data. The evidence collection instruction reception unit 108 receives the evidence collection instruction.

Based on the evidence collection instruction received by the evidence collection instruction reception unit 108, the evidence data collection unit 109 collects evidence data. For example, the measurement unit 104 reads the software used to calculate the hash value from the memory 102 to perform the collection. However, for the dynamic data, the dynamic data stored in the secure memory 105 is collected as evidence data instead of the dynamic data placed in the memory 102. This is because, since the dynamic data changes according to the execution state of the program, the dynamic data used by the measurement unit 104 to calculate the measurement value may differ from the dynamic data placed in the memory 102 when the evidence data collection unit 109 collects the evidence data.

The evidence data transmission unit 110 transmits the collected evidence data to the verifier device 200. When the verifier device 200 is a server device installed outside the vehicle as illustrated in FIG. 1B, the individual ECU 50f, that is, the prover device 100, outputs evidence data to an in-vehicle network such as CAN, and transmits the evidence data from the external communication ECU 50b via the zone ECU 50 and the integrated ECU 50a. In contrast, when the verifier device 200 is an ECU mounted in the vehicle as illustrated in FIG. 1C, the individual ECU 50f, that is, the prover device 100, outputs evidence data to an in-vehicle network such as CAN.

The verification result reception unit 111 receives the verification result information generated by the verifier device 200, based on the measurement result transmitted from the measurement result transmission unit 106. For example, when the verifier device 200 has not detected tampering of software executed in the memory 102 of the prover device 100, the verifier device 200 transmits a verification result to the prover device 100 indicating that the integrity of the software has been confirmed, and the verification result reception unit 111 receives the verification result.

When the verification result reception unit 111 receives the verification result indicating that the integrity of the software has been confirmed, the secure memory 105 discards the stored dynamic data. This is because there is no longer a possibility that the verifier device 200 will require the transmission of the dynamic data used to calculate the measurement value as evidence data.

### (3) Configuration of Verifier Device 200

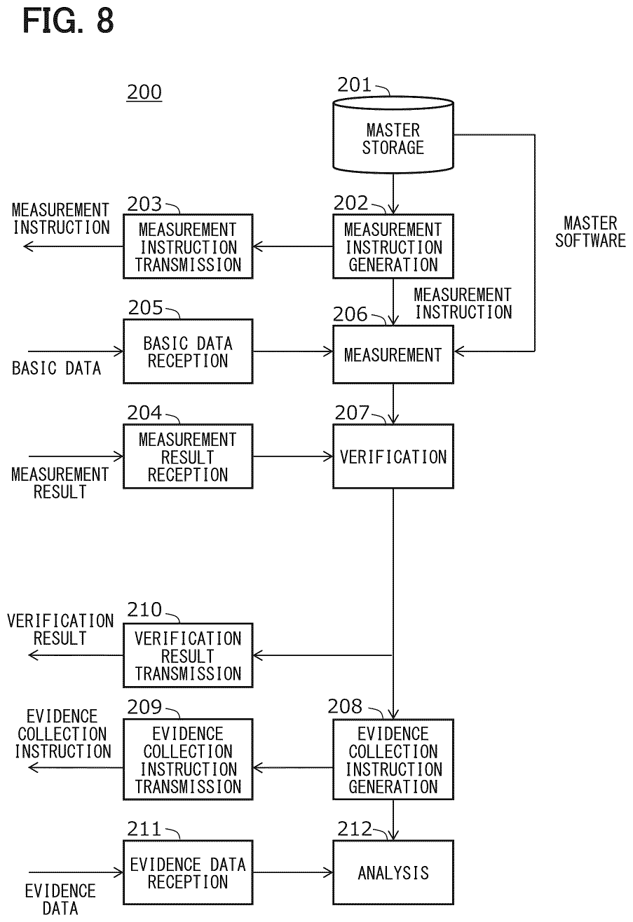

A configuration example of the verifier device 200 according to the present embodiment will be described with reference to FIG. 8. The verifier device 200 includes a master storage unit 201, a measurement instruction generation unit 202, a measurement instruction transmission unit 203, a measurement result reception unit 204, a basic data reception unit 205, a measurement unit 206, a verification unit 207, an evidence collection instruction generation unit 208, an evidence collection instruction transmission unit 209, a verification result transmission unit 210, an evidence data reception unit 211, and an analysis unit 212.

In the master storage unit 201, information regarding software stored or installed in the prover device 100 is stored in advance. This software is software that is executed in the prover device 100 and is a target of the measurement instruction.

The master storage unit 201 may be either an external storage device (hard disk, universal serial bus (USB) memory, compact disc (CD)/Blu-ray disc (BD), etc.) or an internal storage device (RAM, etc.). The device may be volatile or nonvolatile.

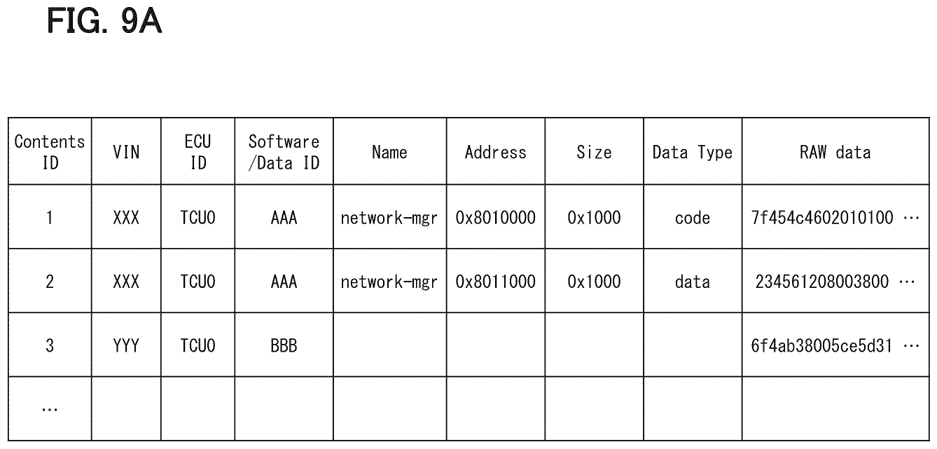

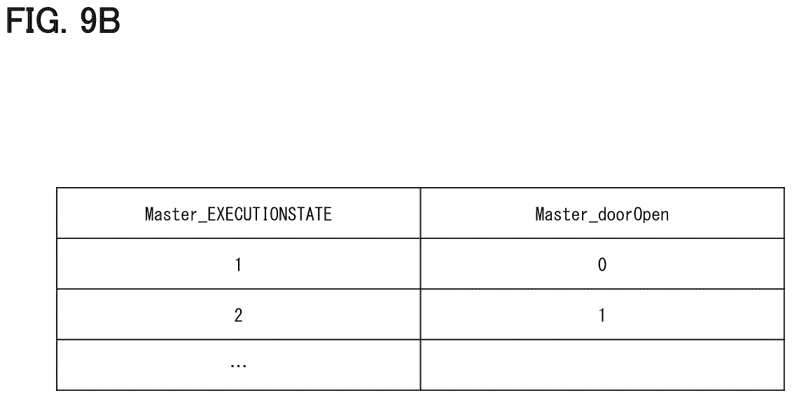

A specific example of the information stored in the master storage unit 201 will be described with reference to FIGS. 9A and 9B.

The master storage unit 201 stores a measurement target table that records information of software to be measured. As illustrated in FIG. 9A, the measurement target table associates and stores a content identifier (Contents ID) that identifies software, a vehicle identifier (VIN) that identifies a vehicle in which the software is mounted, an identifier (ECU ID) of an ECU in which the software is installed, an identifier (Software/Data ID) that identifies a program or data included in the software, the name (Name) of the software, the start position (Address) of the software in memory, the size (Size) of the software, the data type (Data Type) of the software, and raw data (RAW data) of master software, which is a copy of the software installed on the prover device 100.

The master storage unit 201 further stores a dynamic data management table indicating a correspondence between master dynamic data, which is dynamic data (hereinafter referred to as master dynamic data) included in the master software and changes in content according to the execution state of the program, and master basic data that enables the master dynamic data to be estimated. As illustrated in FIG. 9B, in the dynamic data management table, the master basic data (Master_EXECUTIONSTATE) and the master dynamic data (Master_doorOpen) are associated and stored. In the dynamic data management table, a start position (Address) in the memory where the master dynamic data and the master basic data are placed is further associated and stored. The dynamic data management table is a table created during the preparation in the present embodiment.

In FIGS. 9A and 9B, the measurement target table and the dynamic data management table are illustrated as different tables for easy description. However, the master basic data and the master dynamic data included in the dynamic data management table may be managed together in the measurement target table.

The measurement instruction generation unit 202 generates a measurement instruction for the prover device 100. In the present embodiment, a measurement instruction is generated to instruct the calculation of a hash value that is a measurement value of the software executed by the prover device 100.

In the present embodiment, the measurement instruction includes measurement region information indicating a region to be measured in the software. For example, as in the example of FIG. 7A, the measurement instruction includes a nonce and a plurality of pieces of measurement region information (data1, data3, data2), and also includes measurement order information (data1, data3, data2) indicating an order in which the plurality of pieces of measurement region information are to be processed.

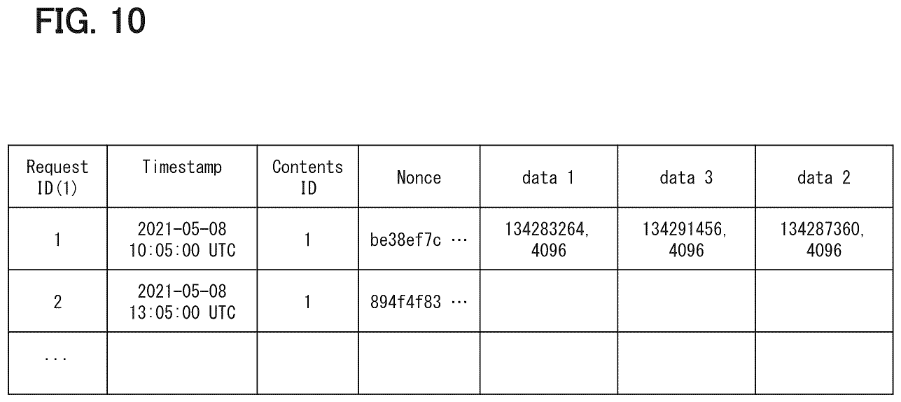

A specific example of the measurement instruction generated by the measurement instruction generation unit 202 will be described with reference to FIG. 10. In the example of FIG. 10, the measurement instruction includes the identifier (Request ID (1)) of the measurement instruction, a time (Timestamp) when the measurement instruction generation unit 202 generates the measurement instruction or when the measurement instruction transmission unit 203 transmits the measurement instruction, a content identifier (Contents ID) that identifies software being executed by the prover device 100, a nonce (Nonce), and measurement region information (data1, data3, data2). When the calculation of the hash value for the entire software is instructed, the measurement region information is unnecessary.

In addition, a vehicle identifier (VIN) that identifies a vehicle, an identifier (ECU ID) of an ECU in which software is installed, and an identifier (Software/Data ID) that identifies a program or data included in executed software may be included.

The measurement instruction transmission unit 203 transmits, to the prover device 100, the measurement instruction generated by the measurement instruction generation unit 202. The timing for transmitting the measurement instruction can be determined arbitrarily. For example, the measurement instruction may be generated and transmitted periodically at regular intervals, or the measurement instruction may be generated and transmitted when an anomaly occurs. Examples of the time when an anomaly occurs include when an anomaly caused by a cyberattack is identified by a vehicle security operation center (SOC) or when a product security incident response team (PSIRT) determines that verification of integrity is necessary. The measurement instruction may be transmitted using, as a verification target, software that includes dynamic data related to the generated anomaly. These examples are compatible when the verifier device 200 is provided outside the vehicle. The examples also include when a security sensor such as a host-based intrusion detection system (IDS) or a network-based intrusion detection system (IDS) provided in the electronic control system S of FIG. 2 detects an anomaly or when the in-vehicle security information and event management (SIEM) has finished selecting an anomaly to be examined. These examples are compatible when the verifier device 200 is provided inside the vehicle.

Other examples of the timing include when an ignition power supply is turned off, and when a power supply is turned off in an ECU of a specific group.

The measurement result reception unit 204 receives a measurement result that is the response of the prover device 100 to the measurement instruction transmitted from the measurement instruction transmission unit 203. For example, when the prover device 100 obtains hash values in FIG. 7B by calculation, these hash values h1, h2, h3 are the measurement results.

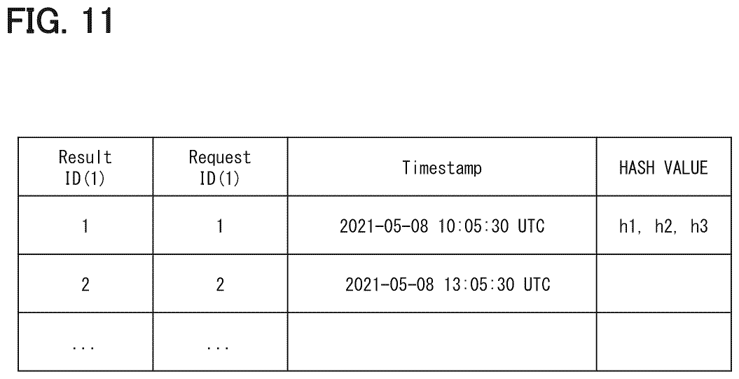

A specific example of the measurement result received by the measurement result reception unit 204 will be described with reference to FIG. 11. In the example of FIG. 11, the measurement result received by the measurement result reception unit 204 includes the identifier (Result ID (1)) of the measurement result, the identifier (Request ID (1)) of the corresponding measurement instruction, a time (Timestamp) when the prover device 100 calculates or transmits the measurement result, and a first hash value that is the measurement result. In the example of FIG. 11, the measurement results are three hash values of h1, h2, and h3. In addition, the measurement result may include a process identification (ID) (PID) of software being executed in the prover device 100.

The basic data reception unit 205 receives, from the prover device 100, basic data enabling the estimation of dynamic data that should be originally placed in the memory of the verifier device 200. For example, when the prover device 100 calculates the hash value using the dynamic data (doorOpen) of the software illustrated in FIG. 4B, the basic data reception unit 205 receives the value of the flag (EXECUTIONSTATE) as the basic data. When the software includes a plurality of pieces of dynamic data, the basic data reception unit 205 receives a plurality of pieces of basic data that enable the plurality of pieces of dynamic data to be estimated.

The measurement unit 206 calculates a second hash value that is the hash value of the master software stored in the master storage unit 201. The hash value is calculated based on the nonce and the measurement region information included in the measurement instruction generated by the measurement instruction generation unit 202. The calculation method is the same as that in FIG. 7B. However, the verifier device 200 does not know which dynamic data should be used to calculate the hash value for the dynamic data that changes in content. Therefore, the measurement unit 206 estimates the dynamic data used to calculate the hash value received by the measurement result reception unit 204 using the basic data received by the basic data reception unit 205, and calculates the second hash value using the estimated dynamic data. Specifically, among the master basic data included in the dynamic data management table, the master dynamic data associated with the master basic data corresponding to the basic data received by the basic data reception unit 205 is estimated to be the dynamic data used by the prover device 100 to calculate the first hash value. The measurement unit 206 calculates the second hash value using the master dynamic data, that is, the estimated dynamic data.

When one master basic data and a plurality of pieces of master dynamic data are associated with each other in the dynamic data management table, the measurement unit 206 calculates a plurality of second hash values by using each of the plurality of pieces of master dynamic data associated with the master basic data corresponding to the basic data received by the basic data reception unit 205.

The verification unit 207 verifies whether the first hash value, which is the measurement result received by the measurement result reception unit 204, matches the second hash value calculated by the measurement unit 206. When the values match, it can be confirmed that the software being executed by the prover device 100 has not been tampered with. When the values do not match, it can be confirmed that the software being executed by the prover device 100 may have been tampered with. If there is a possibility that the software has been tampered with, the verification unit 207 outputs a verification result indicating the possibility to the evidence collection instruction generation unit 208. In contrast, when the software has not been tampered with and the integrity of the software has been confirmed as a result of the verification by the verification unit 207, a verification result indicating the fact is output to the verification result transmission unit 210.

When one master basic data and two master dynamic data are associated with each other in the dynamic data management table, the verification unit 207 verifies whether the first hash value matches any of the plurality of second hash values calculated by the measurement unit 206. When the hash value matches any of the second hash values, it may be determined that the software being executed by the prover device 100 has not been tampered with.

The evidence collection instruction generation unit 208 generates an evidence request instruction for requesting necessary evidence data on the basis of the verification result based on the result of the measurement by the verification unit 207. For example, if the software is suspected of having been tampered with, all or part of the software being executed by the prover device 100 is requested as evidence data to prove tampering or take measures against tampering.

For example, if the first hash values h1, h2, h3, which are the measurement results, all differ from the second hash value, there is a possibility that tampering has been made at least in the data1 region, and thus a part of software corresponding to data1 is requested as evidence. If only h3 of the first hash values differs from the second hash value, it is understood that no tampering has been performed in the data1 and data3 regions, and thus a part of software corresponding to data2 is requested as evidence. In the former case, since there is a possibility that tampering is performed in the data3 and data2 regions, the data3 and data2 regions may also be requested as evidence, or all of the software may be requested as evidence.

In the present embodiment, since the verifier device 200 verifies the integrity of the software that uses the measurement value obtained using the dynamic data, the evidence collection instruction generation unit 208 may always request the raw data of the dynamic data as the evidence data.

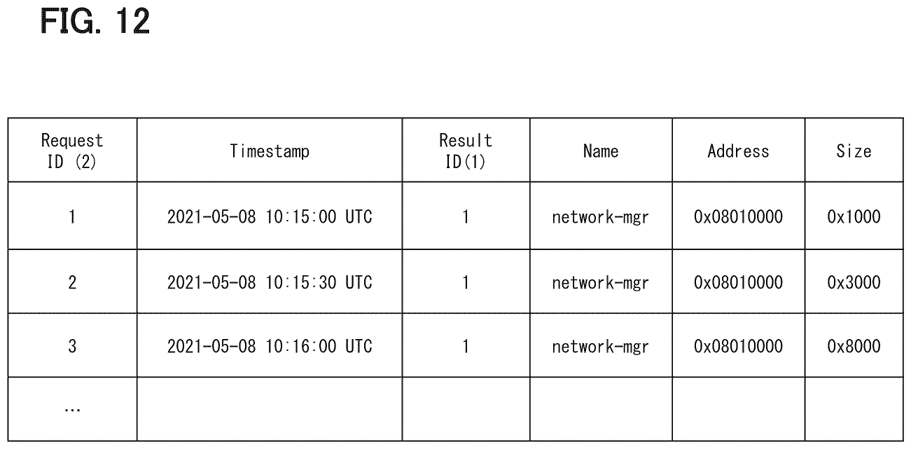

A specific example of the evidence collection instruction generated by the evidence collection instruction generation unit 208 will be described with reference to FIG. 12. In the example of FIG. 12, the evidence collection instruction includes the identifier (Request ID (2)) of the evidence collection instruction, a time (Timestamp) when the evidence collection instruction generation unit 208 generates the evidence collection instruction or when the evidence collection instruction transmission unit 209 transmits the evidence collection instruction, the identifier (Result ID (1)) of the measurement result that has caused the evidence collection instruction to be generated, the name (Name) of the software that is the requested evidence data, the start position (Address) of the software in the memory, and the size (Size) of the software.

In FIG. 12, the evidence collection instruction (Request ID (2): 1) in the first row is an example of requesting only data1 since the start position and the size of data1 are designated. The evidence collection instruction (Request ID (2): 2) in the second row is an example of requesting data1, data3, and data2 since the start position of data1 and the total size of data1, data3, and data2 are designated. The evidence collection instruction (Request ID (2): 3) on the third line is an example of requesting the entire software since the start position of data1 and the size of the entire target software are designated.

The evidence collection instruction transmission unit 209 transmits, to the prover device 100, the evidence collection instruction generated by the evidence collection instruction generation unit 208.

The verification result transmission unit 210 transmits, to the prover device 100, a verification result indicating that the integrity of the software has been confirmed on the basis of the verification result based on the result of the measurement by the verification unit 207.

The evidence data reception unit 211 receives evidence data from the prover device 100. The received evidence data is output to the analysis unit 212.

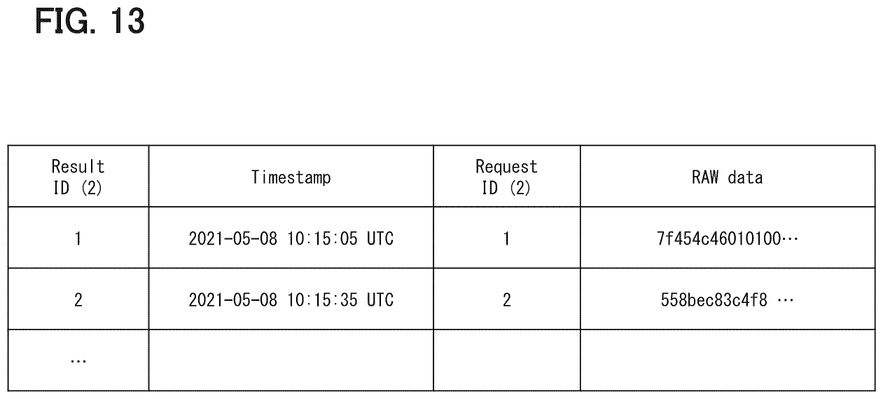

A specific example of the evidence data received by the evidence data reception unit 211 will be described with reference to FIG. 13. In the example of FIG. 13, the evidence data includes the identifier (Result ID (2)) of the evidence data, a time (Timestamp) when the evidence data reception unit 211 receives the evidence data, the identifier (Request ID (2)) of the corresponding evidence collection instruction, and the raw data (RAW data) of the software that is the evidence data.

The analysis unit 212 analyzes the evidence data received by the evidence data reception unit 211. For example, the analysis unit 212 analyzes, based on the evidence data, whether the software has been tampered with and a problem caused if the software has been tampered with. Moreover, an attack that has caused tampering may be identified, and a countermeasure against the attack may be executed.

In the present embodiment, the case where the basic data is a flag enabling the identification of dynamic data that should be originally placed in the memory has been described as an example. However, the basic data may be a flag enabling the identification of dynamic data that should not be originally placed in the memory.

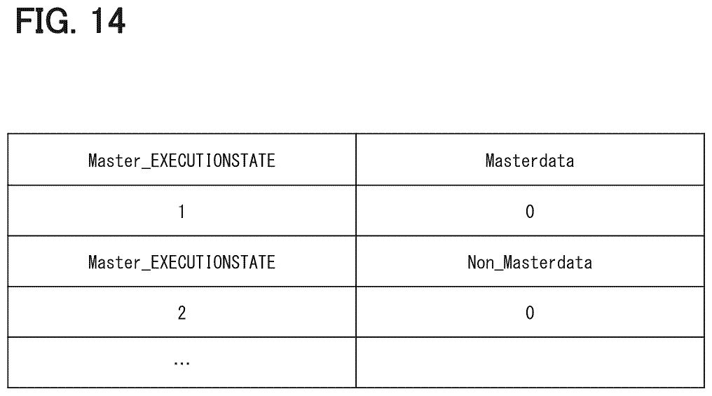

FIG. 14 illustrates a modification of the dynamic data management table. In the dynamic data management table of FIG. 14, in addition to the master basic data (Master_EXECUTIONSTATE) and the master dynamic data (Masterdata) being associated and stored as in FIG. 9B, the master basic data (Master_EXECUTIONSTATE) and non-master dynamic data (Non_Masterdata) are associated and stored. This dynamic data management table indicates that the master dynamic data is a value other than [0] when the master basic data is [2]. Therefore, when the basic data received by the basic data reception unit 205 is [2], the verification unit 207 can estimate that the dynamic data is other than the master dynamic data associated with the master basic data [2] corresponding to this basic data, that is, other than [0].

When the master basic data corresponding to the basic data is associated with the non-master dynamic data from the prover device 100, the measurement unit 206 calculates the second hash value using the non-master dynamic data. The verification unit 207 verifies whether the first hash value and the second hash value, which are the measurement results received by the measurement result reception unit 204, match each other. When the first hash value and the second hash value do not match, it is confirmed that the software being executed by the prover device 100 has not been tampered with. In contrast, when the values match, it is confirmed that the software being executed by the prover device 100 may have been tampered with.

### (4) Operations of the Prover Device 100 and the Verifier Device 200

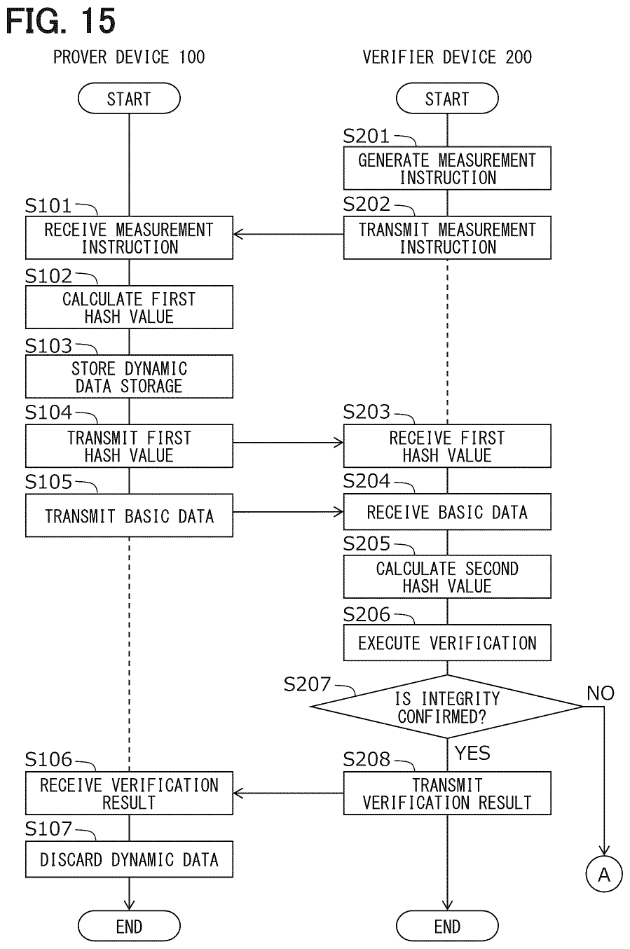

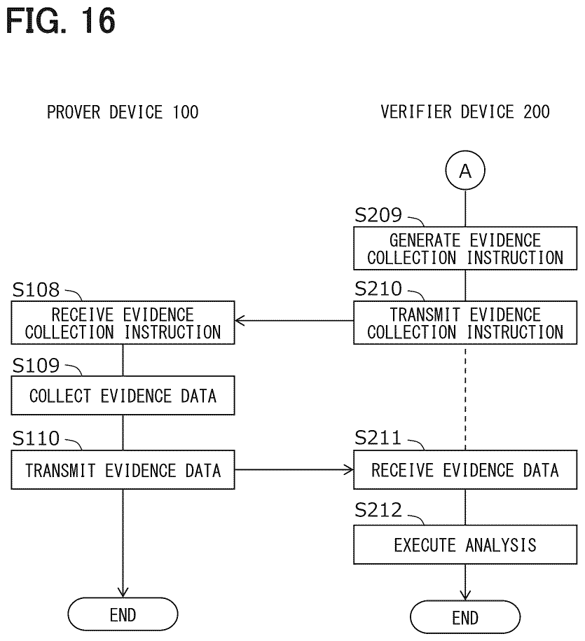

The operations of the prover device 100 and the verifier device 200 will be described with reference to FIGS. 15 and 16. FIGS. 15 and 16 illustrate not only a verification method executed by the prover device 100 and the verifier device 200 but also a processing procedure for a verification program executable by these devices. The processing to be described is not limited to the order indicated in FIGS. 15 and 16. That is, the order may be interchanged unless there are restrictions, such as a relationship in which one step uses the result of its preceding step. The same applies to an embodiment to be described later.

The measurement instruction generation unit 202 of the verifier device 200 generates a measurement instruction (S201).

The measurement instruction transmission unit 203 transmits the measurement instruction generated in S201 to the prover device 100 (S202).

The measurement instruction reception unit 103 of the prover device 100 receives the measurement instruction from the verifier device 200 (S101).

Based on the measurement instruction received in S101, the measurement unit 104 calculates a first hash value that is a measurement value of software including dynamic data (S102).

The dynamic data used to calculate the first hash value by the measurement unit 104 is stored in the secure memory 105 (S103).

The measurement result transmission unit 106 transmits the first hash value calculated in S102 to the verifier device 200 (S104).

The basic data transmission unit 107 transmits, to the verifier device 200, basic data enabling the estimation of dynamic data that should be originally placed in the memory 102 (S105).

The measurement result reception unit 204 of the verifier device 200 receives the first hash value from the prover device 100 (S203).

The basic data reception unit 205 receives the basic data from the prover device 100 (S204).

The measurement unit 206 calculates the second hash value using the master dynamic data associated with the master basic data corresponding to the basic data received in S204 (S205).

The verification unit 207 verifies whether the first hash value received in S203 matches the second hash value calculated in S205 (S206).

When the first hash value and the second hash value match and the integrity of the software is confirmed (S207: Y), a verification result indicating the match is transmitted to the prover device 100 (S208).

The verification result reception unit 111 receives the verification result from the verifier device 200 (S106).

The secure memory 105 discards the stored dynamic data (S107).

In contrast, when, as a result of the verification by the verification unit 207, the first hash value and the second hash value do not match and there is a possibility that the software has been tampered with (S207: N), the evidence collection instruction generation unit 208 generates an evidence collection instruction for requesting evidence data (S209).

The evidence collection instruction transmission unit 209 transmits the evidence collection instruction generated in S209 to the prover device 100 (S210).

The evidence collection instruction reception unit 108 receives the evidence collection instruction from the verifier device 200 (S108).

The evidence data collection unit 109 collects evidence data based on the evidence collection instruction (S109).

The evidence data transmission unit 110 transmits the evidence data collected in S109 to the verifier device 200 (S110).

The evidence data reception unit 211 receives the evidence data from the prover device 100 (S211).

The analysis unit 212 analyzes the received evidence data (S212).

### (5) Summary

As described above, according to the verifier device 200 of the present embodiment, even if software includes dynamic data that changes in content, basic data enabling the identification of dynamic data that should be originally placed in memory can be acquired to estimate dynamic data used to calculate a measurement value, thereby verifying the integrity of the software.

### 3. Second Embodiment

In the first and second embodiments described above, the verifier device 200 has verified the integrity of the software by determining whether the hash value calculated using the dynamic data received from the prover device 100 matches the hash value calculated using the dynamic data estimated from the received basic data. In the present embodiment, the verifier device receives the raw data of the dynamic data from the prover device and verifies the integrity of the dynamic data by determining whether the received raw data of the dynamic data matches the raw data of the dynamic data estimated from the received basic data.

### (1) Configuration of Prover Device 150

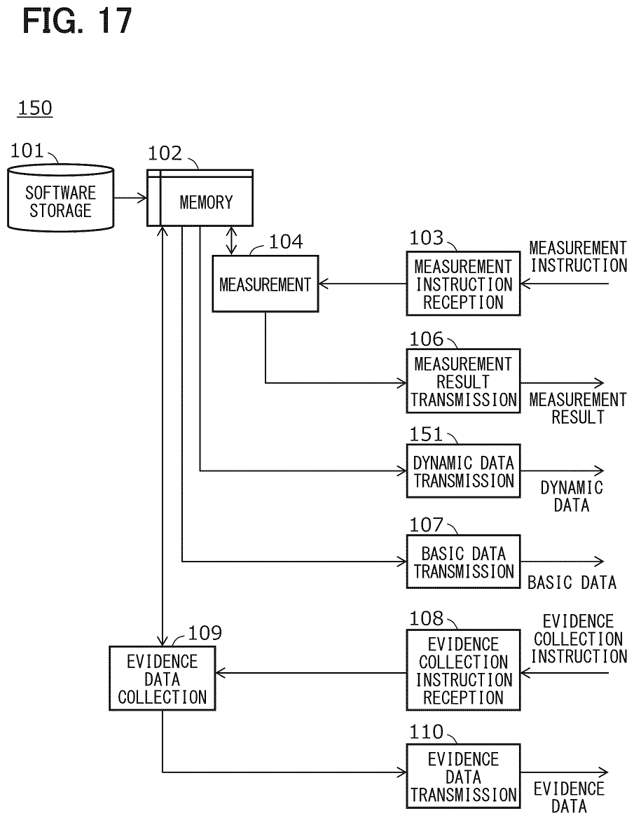

With reference to FIG. 17, the configuration of the prover device 150 of the present embodiment will be described focusing on differences from the first embodiment.

Unlike the prover device 100 of the first embodiment, the prover device 150 includes a dynamic data transmission unit 151. The dynamic data transmission unit 151 transmits, to the verifier device 200, the raw data of the dynamic data included in the software placed in the memory 102.

Based on the measurement instruction, the measurement unit 104 calculates a measurement value using only the part of the software excluding the dynamic data. Alternatively, a measurement value may be calculated using software including dynamic data.

Unlike the prover device 100 of the first embodiment, the prover device 150 does not include the secure memory 105 and the verification result reception unit 111. This is because the dynamic data transmission unit 151 transmits the raw data of the dynamic data, and thus it is not necessary to store the raw data of the dynamic data in the secure memory 105.

### (2) Configuration of Verifier Device 250

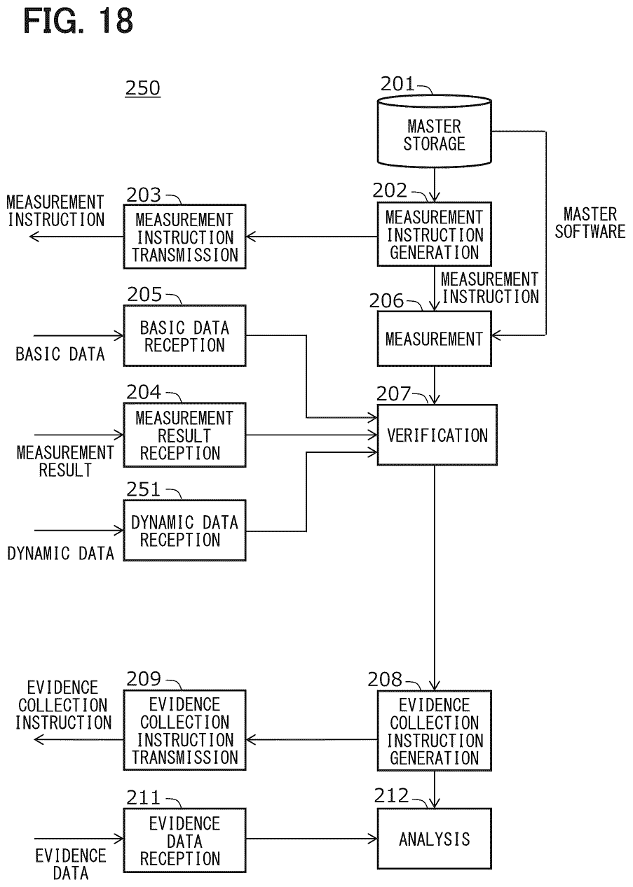

With reference to FIG. 18, the configuration of the verifier device 250 of the present embodiment will be described focusing on differences from the first embodiment.

Unlike the verifier device 250 of the first embodiment, the verifier device 200 includes a dynamic data reception unit 251. The dynamic data reception unit 251 receives the raw data of the dynamic data included in the software from the prover device 150.

The verification unit 207 verifies whether the dynamic data received by the dynamic data reception unit 251 matches the master dynamic data associated with the master basic data corresponding to the basic data received by the basic data reception unit 205. When the values match, it can be confirmed that the dynamic data has not been tampered with. When the values do not match, it can be confirmed that the dynamic data disposed in the memory 102 of the prover device 150 may have been tampered with.

Similarly to the first embodiment, the measurement unit 206 calculates a second hash value that is the hash value of the master software stored in the master storage unit 201. When the region where the dynamic data is placed is not included in the measurement instruction generated by the measurement instruction generation unit 202, the measurement unit 206 only needs to calculate a second hash value that is the hash value of the master software stored in the master storage unit 201. In contrast, when the measurement instruction generated by the measurement instruction generation unit 202 includes a region where the dynamic data is placed, the measurement unit 206 calculates a second hash value by using the dynamic data confirmed not to be tampered with as a result of verification by the verification unit 207.

As a result of the verification by the verification unit 207, if there is a possibility that the dynamic data has been tampered with, it is also possible that the dynamic data placed in the memory 102 has been tampered with, as well as the program that sets the dynamic data. Therefore, the evidence collection instruction generation unit 208 generates an evidence collection instruction that requests software including dynamic data as evidence data.

On the other hand, as a result of the verification by the verification unit 207, the integrity of the dynamic data has been confirmed, but when the first hash value and the second hash value do not match, it can be confirmed the software may have been tampered with. Therefore, the evidence collection instruction generation unit 208 generates an evidence collection instruction that requests software excluding dynamic data as evidence data.

The present embodiment describes a configuration in which verification is performed to determine whether hash values calculated using software, excluding or including dynamic data, match, in addition to verifying the raw data of the dynamic data. However, the verifier device 250 may be configured to only verify the raw data of the dynamic data. In this case, instead of the measurement instruction, a dynamic data transmission instruction is transmitted from the verifier device 250 to the prover device 150.

The verifier device 250 of the present embodiment does not include the verification result transmission unit 210. This is because, in the present embodiment, it is not necessary to transmit a verification result indicating that the integrity of the software has been confirmed so that the prover device 150 can discard the dynamic data stored in the secure memory 105.

### (3) Operations of Remote Attestation System 1

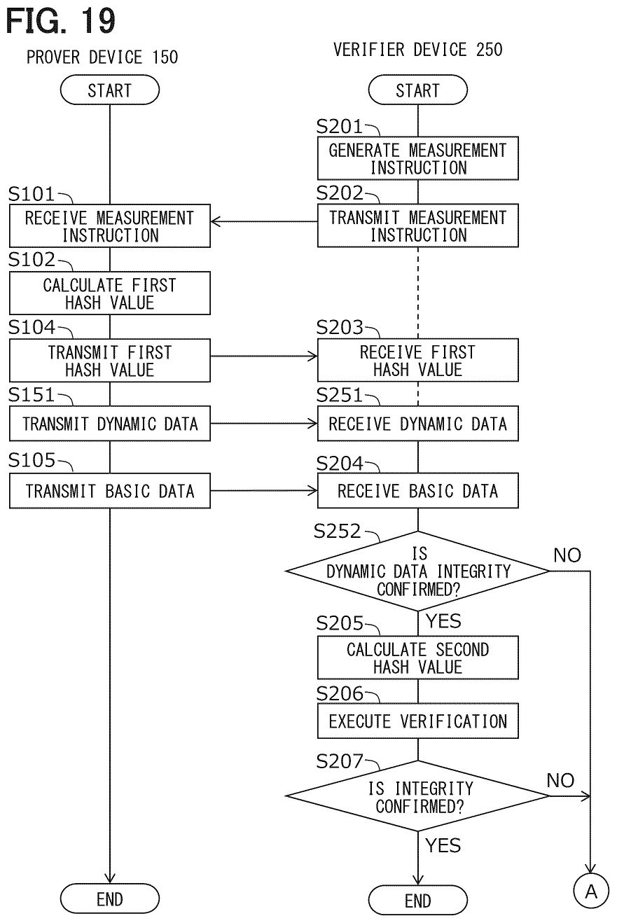

With reference to FIG. 19, the operations of the prover device 150 and the verifier device 250 of the present embodiment will be described focusing on differences from the first embodiment.

The dynamic data transmission unit 151 of the prover device 150 transmits dynamic data to the verifier device 250 (S151).

The dynamic data reception unit 251 of the verifier device 250 receives the dynamic data from the prover device 150 (S251).

The verifier device 250 verifies whether the dynamic data received in S251 matches the master dynamic data associated with the master basic data corresponding to the basic data received in S204. When the dynamic data matches the master dynamic data and the integrity of the dynamic data is confirmed (S252: Y), the second hash value is calculated using the software stored in the master storage unit 201 (S205). When the measurement instruction generated in S201 includes the measurement instruction for the region where the dynamic data is placed, in S205, the second hash value is calculated using the dynamic data with its integrity confirmed in S252.

The processing when the integrity of the dynamic data cannot be confirmed (S252: N) and the processing when the integrity of the software cannot be confirmed (S207: N) are the same as those in FIG. 15 of the first embodiment.

### (4) Summary

As described above, according to the present embodiment, the integrity of the dynamic data can be verified using the raw data of the dynamic data.

### 4. Modifications

In the embodiment described above, the case where the dynamic data is data that changes in content according to the execution state of the program has been described. In the present modification, a case where the dynamic data is data that changes in content according to the state of the vehicle will be described. In the present embodiment, as illustrated in FIGS. 1B and 1C, it is assumed that the prover device 100 is mounted in a vehicle.

Examples of the dynamic data that changes in content according to the state of the vehicle include dynamic data indicating a shift position. Since the shift position changes according to the position of the shift lever, that is, the state of the vehicle, the content of the dynamic data indicating the shift position also changes according to the state of the vehicle. Another example of the dynamic data that changes in content according to the state of the vehicle is dynamic data indicating the open or closed state of the door or the hood of the vehicle. The content of such dynamic data changes according to whether the door or the hood of the vehicle is open, that is, the state of the vehicle. Each of the dynamic data described above is data that changes to predetermined content according to the state of the vehicle. For example, the dynamic data indicating the shift position is any one of D, N, R, or P, and no other content. The dynamic data indicating the open/closed state of the door or the hood of the vehicle has content indicating either open or closed, and no other content. The dynamic data described above is merely an example, and is not limited to this example.

Hereinafter, a case where the present modification is applied to the first embodiment will be described as an example, but the present modification may be applied to the second embodiment.

### (1) Configuration of the Prover Device 100

The configuration of the prover device 100 of the present embodiment will be described with reference to FIG. 6.

As in the first embodiment, the prover device 100 of the present embodiment reads software stored in the software storage unit 101 into the memory 102 to place and execute the software in the memory. However, program code for setting a flag is not inserted into the software stored in the software storage unit 101 of the present embodiment as in the first embodiment.

Based on the measurement instruction received by the measurement instruction reception unit 103, the measurement unit 104 reads software including dynamic data placed in the memory 102 and calculates a measurement value. As described above, the dynamic data of the present modification is dynamic data that changes in content according to the state of the vehicle.

The basic data transmission unit 107 transmits, to the verifier device 200, basic data enabling the estimation of dynamic data that should be originally placed in the memory 102. In the present embodiment, the basic data transmission unit 107 transmits data indicating the state of the vehicle as basic data.

There are cases where the shift position can be estimated by comprehensively considering information such as speed, acceleration, engine speed, and parking brake. For example, the shift position is estimated to be P in a state where the speed, the acceleration, and the engine speed are all 0 and the side brake has been applied. On the other hand, the shift position is estimated to be D when the speed, the acceleration, and the engine speed are higher than predetermined thresholds. As described above, there are cases where the dynamic data can be estimated based on a plurality of pieces of data indicating the state of the vehicle. Therefore, the basic data transmission unit 107 of the present embodiment transmits a plurality of pieces of data indicating the state of the vehicle as basic data to the verifier device 200.

### (2) Configuration of Verifier Device 200

The configuration of the verifier device 200 of the present embodiment will be described with reference to FIG. 8.

Similarly to the first embodiment, the master storage unit 201 of the present modification stores a dynamic data management table that associates master basic data with master dynamic data. However, in the present modification, the master dynamic data included in the dynamic data management table is associated with a plurality of pieces of basic data indicating the state of the vehicle.

The basic data reception unit 205 receives data indicating the state of the vehicle as basic data from the prover device 100.

The measurement unit 206 calculates the second hash value using the master dynamic data associated with the master basic data corresponding to the basic data received by the basic data reception unit 205.

### (3) Summary

As described above, according to the present modification, even if the software includes dynamic data that changes in content according to the state of the vehicle, the data indicating the state of the vehicle can be acquired as basic data enabling the identification of dynamic data that should originally be placed in the memory to estimate the dynamic data used to calculate the measurement value, thereby verifying the integrity of the software.

### 5. General Remarks

The features of the verifier device, the verification method, the verification program, and the remote attestation system in each embodiment of the present disclosure have been described above.

Since the terms used in each embodiment are examples, these may be replaced with terms that are synonymous or include synonymous functions.

The block diagram used for the description of each embodiment is obtained by classifying and arranging the configuration of the device by function. The block showing each function is implemented by any combination of hardware and software. In addition, since the functions are shown, the block diagram can be understood as a disclosure of a method and a disclosure of a program to implement the method.

The order of the functional blocks that can be understood as the processing, the flow, and the method described in each embodiment may be changed unless there are restrictions, such as a relationship in which one step uses the result of another step in the preceding step.

The terms first, second, or N (N is an integer) used in each embodiment and the claims are used to distinguish between two or more configurations or methods of the same type and do not limit the order or superiority.

The following are examples of the forms of devices of the present disclosure.

Examples of the form of the component include a semiconductor element, an electronic circuit, a module, and a microcomputer.

Examples of the form of the semi-finished product include an electronic control device (electric control unit, ECU) and a system board.

Examples of the form of the finished product include a mobile phone, a smartphone, a tablet, a personal computer (PC), a workstation, and a server.

In addition, devices with communication functions, and the like are included, and examples thereof include a video camera, a still camera, and a car navigation system.

To each device, necessary functions such as an antenna and a communication interface may be added.

The verifier device of the present disclosure is assumed to be used for the purpose of providing various services, especially when used on the server side. With the provision of such services, the verifier device of the present disclosure will be used, the verification method of the present disclosure will be used, and/or the verification program of the present disclosure will be executed.

In addition, the present disclosure can be implemented not only with dedicated hardware configured and functioning as described in each embodiment, but also through a combination of a program, recorded in a recording medium such as memory or a hard disk, for realizing the present disclosure with general-purpose hardware, including a dedicated or general-purpose CPU, memory, and the like, capable of executing the program.

The program stored in a non-transitory tangible recording medium (e.g., an external storage device (hard disk, USB memory, CD/BD, etc.) or an internal storage device (RAM, ROM, etc.)) of dedicated or general-purpose hardware can also be provided to dedicated or general-purpose hardware via a recording medium, or from a server via a communication line without a recording medium. As a result, it is possible to always provide the latest functions through program upgrade.

The present disclosure has mainly described the case where an in-vehicle electronic control device mounted in an automobile is used as a prover device. However, the present disclosure can be applied to all moving objects such as motorcycles, ships, trains, and aircraft. The present disclosure is applicable not only to moving objects but also to all products including microcomputers.

### (Examples of the Technical Concepts Disclosed Herein)

### (Item 1)

A verifier device constituting a remote attestation system together with a prover device, the verifier device comprising:
a dynamic data reception unit configured to receive dynamic data or a measurement value calculated using the dynamic data from the prover device that places and executes a software in a memory, the software including the dynamic data whose content changes;
a basic data reception unit configured to receive basic data from the prover device, the basic data being capable of estimating the dynamic data that should originally be placed in the memory;
a master storage unit configured to store master dynamic data, whose data content changes, and which is included in master software that is a copy of the software, and master basic data, which is capable of estimating the master dynamic data, in association with each other;
a verification unit configured to verify the dynamic data or the measurement value received by the dynamic data reception unit using the master dynamic data associated with the master basic data corresponding to the basic data and to output a verification result.

### (Item 2)

The verifier device according to item 1, wherein
the dynamic data is data whose content changes according to an execution state of a program, and
the software includes a first program code that sets the dynamic data that should originally be placed in the memory, and a second program code that sets a flag capable of identifying the dynamic data as the basic data.

### (Item 3)

The verifier device according to item 2, wherein
the second program code is inserted immediately before or immediately after the first program code.

### (Item 4)

The verifier device according to item 2, wherein
the measurement value is a measurement value calculated using the dynamic data, the first program code, and the second program code.

### (Item 5)

The verifier device according to item 1, wherein
the prover device is an electronic control device mounted in a mobile object, and
the dynamic data is data whose content changes according to a state of the mobile object.

### (Item 6)

The verifier device according to item 5, wherein
the basic data is data indicating the state of the mobile object.

### (Item 7)

The verifier device according to item 1, wherein
the software includes a plurality of dynamic data,
the measurement value is a measurement value calculated using the plurality of dynamic data, and
the basic data reception unit receives a plurality of basic data, each capable of estimating the plurality of dynamic data.

### (Item 8)

The verifier device according to item 1, wherein
the measurement value is a hash value.

### (Item 9)

The verifier device according to item 1, further comprising:
an evidence collection instruction generation unit configured to generate an evidence collection instruction requesting evidence data from the prover device based on the verification result of the verification unit;
an evidence collection instruction transmission unit configured to transmit the evidence collection instruction to the prover device; and
an evidence data reception unit configured to receive the evidence data from the prover device in response to the evidence collection instruction,
wherein
when the dynamic data reception unit receives the measurement value, the evidence collection instruction generation unit generates the evidence collection instruction requesting the dynamic data as the evidence data.

### (Item 10)

The verifier device according to any one of item 1 to item 9, wherein
the verifier device is a server device installed outside a mobile object.

### (Item 11)

The verifier device according to any one of item 1 to item 9, wherein
the verifier device is an electronic control device mounted in a mobile object.

What is claimed is:

1. A verifier device constituting a remote attestation system together with a prover device, the verifier device comprising:
a dynamic data reception unit configured to receive dynamic data or a measurement value calculated using the dynamic data from the prover device that places and executes a software in a memory, the software including the dynamic data whose content changes;
a basic data reception unit configured to receive basic data from the prover device, the basic data being capable of estimating the dynamic data that should originally be placed in the memory;
a master storage unit configured to store master dynamic data, whose data content changes, and which is included in master software that is a copy of the software, and master basic data, which is capable of estimating the master dynamic data, in association with each other;
a verification unit configured to verify the dynamic data or the measurement value received by the dynamic data reception unit using the master dynamic data associated with the master basic data corresponding to the basic data and to output a verification result.

2. The verifier device according to claim 1, wherein
the dynamic data is data whose content changes according to an execution state of a program, and
the software includes a first program code that sets the dynamic data that should originally be placed in the memory, and a second program code that sets a flag capable of identifying the dynamic data as the basic data.

3. The verifier device according to claim 2, wherein
the second program code is inserted immediately before or immediately after the first program code.

4. The verifier device according to claim 2, wherein
the measurement value is a measurement value calculated using the dynamic data, the first program code, and the second program code.

5. The verifier device according to claim 1, wherein
the prover device is an electronic control device mounted in a mobile object, and
the dynamic data is data whose content changes according to a state of the mobile object.

6. The verifier device according to claim 5, wherein
the basic data is data indicating the state of the mobile object.

7. The verifier device according to claim 1, wherein
the software includes a plurality of dynamic data,
the measurement value is a measurement value calculated using the plurality of dynamic data, and
the basic data reception unit receives a plurality of basic data, each capable of estimating the plurality of dynamic data.

8. The verifier device according to claim 1, wherein
the measurement value is a hash value.

9. The verifier device according to claim 1, further comprising:
an evidence collection instruction generation unit configured to generate an evidence collection instruction requesting evidence data from the prover device based on the verification result of the verification unit;
an evidence collection instruction transmission unit configured to transmit the evidence collection instruction to the prover device; and
an evidence data reception unit configured to receive the evidence data from the prover device in response to the evidence collection instruction,
wherein
when the dynamic data reception unit receives the measurement value, the evidence collection instruction generation unit generates the evidence collection instruction requesting the dynamic data as the evidence data.

10. The verifier device according to claim 1, wherein
the verifier device is a server device installed outside a mobile object.

11. The verifier device according to claim 1, wherein
the verifier device is an electronic control device mounted in a mobile object.

12. A remote attestation system comprising:
the verifier device according to claim 1; and
a prover device,
wherein
the prover device includes:
a measurement result transmission unit that transmits the measurement value, which is calculated using the dynamic data, to the verifier device;
a basic data transmission unit that transmits the basic data to the verifier device; and
a secure memory that stores the dynamic data used in calculation of the measurement value transmitted to the verifier device.

13. The remote attestation system according to claim 12, wherein
the verifier device further includes a verification result transmission unit that transmits a verification result indicating that integrity of the software has been confirmed to the prover device, and
the prover device further includes a verification result reception unit that receives the verification result from the verifier device, and
the secure memory discards the dynamic data when information of the verification result is received.

14. A verification method executed by a verifier device constituting a remote attestation system together with a prover device, wherein the verifier device comprises a master storage unit configured to store master dynamic data, which is included in master software that is a copy of the software executed by the prover device, and master basic data, which is capable of estimating the master dynamic data, in association with each other, the verification method comprising:
receiving, from the prover device that places and executes the software including dynamic data whose content changes in a memory, the dynamic data or a measurement value calculated using the dynamic data;
receiving, from the prover device, basic data capable of estimating the dynamic data that should originally be placed in the memory;
verifying the dynamic data or the measurement value received by a dynamic data reception unit using the master dynamic data associated with the master basic data corresponding to the basic data; and
outputting a verification result.

15. A non-transitory computer-readable storage medium storing a verification program executable by a verifier device constituting a remote attestation system together with a prover device, wherein the verifier device comprises a master storage unit that stores master dynamic data, which is included in master software that is a copy of the software executed by the prover device, and master basic data, which is capable of estimating the master dynamic data, in association with each other, the verification program causing the verifier device to execute:
receiving, from the prover device that places and executes the software including dynamic data whose content changes in a memory, the dynamic data or a measurement value calculated using the dynamic data;
receiving, from the prover device, basic data capable of estimating the dynamic data that should originally be placed in the memory;
verifying the dynamic data or the measurement value received by a dynamic data reception unit using the master dynamic data associated with the master basic data corresponding to the basic data; and
outputting a verification result.
